(19) United States
(12) Patent Application Publication
(10) Pub. No.: US 2012/0213586 A1
(43) Pub. Date: Aug. 23, 2012

(54) Wrapper Tip Assembly For Compactor Wheel Assembly

(75) Inventor: Vinayak R. Ugru, Sugar Grove, IL (US)

(73) Assignee: CATERPILLAR, INC., Peoria, IL (US)

(21) Appl. No.: 13/032,939

(22) Filed: Feb. 23, 2011

(51) Int. Cl. E01C 19/26; B23P 6/00; E01C 19/27

(52) U.S. Cl. 404/121; 404/128; 29/402.08

(57) ABSTRACT

A compactor wheel assembly includes a cylindrical wheel base having a ground engaging wear surface, and a wrapper tip assembly including a wheel tip and a wrapper plate. The wrapper plate includes a replacement material portion positioned over a wear depression of the ground engaging wear surface.

### TECHNICAL FIELD

The present disclosure relates generally to a wrapper tip assembly, and more particularly to a wrapper tip assembly that includes a replacement material portion for a ground engaging wear surface of a compactor wheel assembly.

### BACKGROUND

A compactor is a type of machine that is commonly used to pack down and hence increase a load supporting capacity of materials, such as waste or soil. For example, a compactor may be used at a landfill to crush waste and refuse materials, or at a construction site to compact earth, including dirt and rock. Compactors typically have cylindrical wheels or rollers that are used to crush the waste or soil as the compactor is moved throughout the job site. In the case of soil or waste compactors, wheel tips, or teeth, may be supported about external surfaces of the wheels or rollers to improve compaction and/or traction capabilities of the ground engaging wheels or rollers of the compactor. Surfaces of the compactor wheel tips, and other ground engaging surfaces of the compactor wheels or rollers, are subject to wear that, over time, may degrade performance of the compactor.

After a period of wear, the compactor wheel tips may be removed from the compactor wheel and replaced with new wheel tips. Although this operation may restore a desired level of compaction and/or fraction, it may have adverse effects on the surface of the compactor wheel. For example, according to one replacement strategy, the removal and replacement of weld joints used to attach the wheel tips to the compactor wheel may compromise the structural integrity of all or portions of the compactor wheel. As a result, the compactor wheel may only support a limited number of wheel tip replacements before the compactor wheel itself, or a support surface thereof, requires replacement.

A wheel tip replacement strategy is provided in U.S. Pat. No. 3,922,106 to Caron et al. As taught in the Caron patent, wheel tips, or feet, may include replaceable wear caps. Specifically, the feet may include wear caps that are welded to base portions, which, in turn, are welded to a rim. Once worn, the wear cap may be removed from the base portion, at the welded joint, and replaced with a new wear cap.

The present disclosure is directed to one or more of the problems set forth above.

### SUMMARY OF THE DISCLOSURE

In one aspect, a compactor wheel assembly includes a cylindrical wheel base having a ground engaging wear surface, and a wrapper tip assembly including a wheel tip and a wrapper plate. The wrapper plate includes a replacement material portion positioned over a wear depression of the ground engaging wear surface.

In another aspect, a wrapper tip assembly for a compactor wheel assembly includes an arcuate wrapper plate having a uniform thickness. A wheel tip is attached to the arcuate wrapper plate and includes a wheel tip cap and a wheel tip base. The wheel tip covers a ground engaging wear surface of the arcuate wrapper plate.

In yet another aspect, a method of servicing a compactor wheel assembly includes a step of attaching a wrapper tip assembly at a wear position of a cylindrical wheel base. The method also includes a step of removing a previously attached wheel tip from another position of the cylindrical wheel base that is different from the wear position. The attaching step includes positioning a replacement material portion of the wrapper tip assembly over a wear depression of a ground engaging wear surface of the cylindrical wheel base.

### BRIEF DESCRIPTION OF THE DRAWINGS

FIG. 1 is a side diagrammatic view of a compactor, according to the present disclosure;

FIG. 2 is a perspective view of a compactor wheel assembly that may be used with the compactor of FIG. 1, according to one aspect of the present disclosure;

FIG. 3 is a perspective view of one embodiment of an inner wrapper tip assembly of FIG. 2, according to another aspect of the present disclosure;

FIG. 4 is a perspective view of a wrapper tip assembly casting including a wheel tip base and a wrapper plate, according to another aspect of the present disclosure;

FIG. 5 is a perspective view of one embodiment of an outer wrapper tip assembly of FIG. 2, according to another aspect of the present disclosure;

FIG. 6 is a perspective view of a compactor wheel assembly at one stage of servicing, according to another aspect of the present disclosure;

FIG. 7 is a cross sectional view of a portion of the compactor wheel assembly according to FIG. 6;

FIG. 8 is a perspective view of the compactor wheel assembly of FIG. 6 shown at another stage of servicing, according to another aspect of the present disclosure;

FIG. 9 is a cross sectional view of a portion of the compactor wheel assembly according to FIG. 8;

FIG. 10 is a perspective view of the compactor wheel assembly of FIG. 6 shown at another stage of servicing, according to another aspect of the present disclosure;

FIG. 11 is a cross sectional view of a portion of the compactor wheel assembly according to FIG. 10;

FIG. 12 is a perspective view of the compactor wheel assembly of FIG. 6 shown at another stage of servicing, according to another aspect of the present disclosure;

FIG. 13 is a cross sectional view of a portion of the compactor wheel assembly according to FIG. 12;

FIG. 14 is a perspective view of the compactor wheel assembly of FIG. 6 shown at another stage of servicing, according to another aspect of the present disclosure; and

FIG. 15 is a cross sectional view of a portion of the compactor wheel assembly according to FIG. 14.

### DETAILED DESCRIPTION

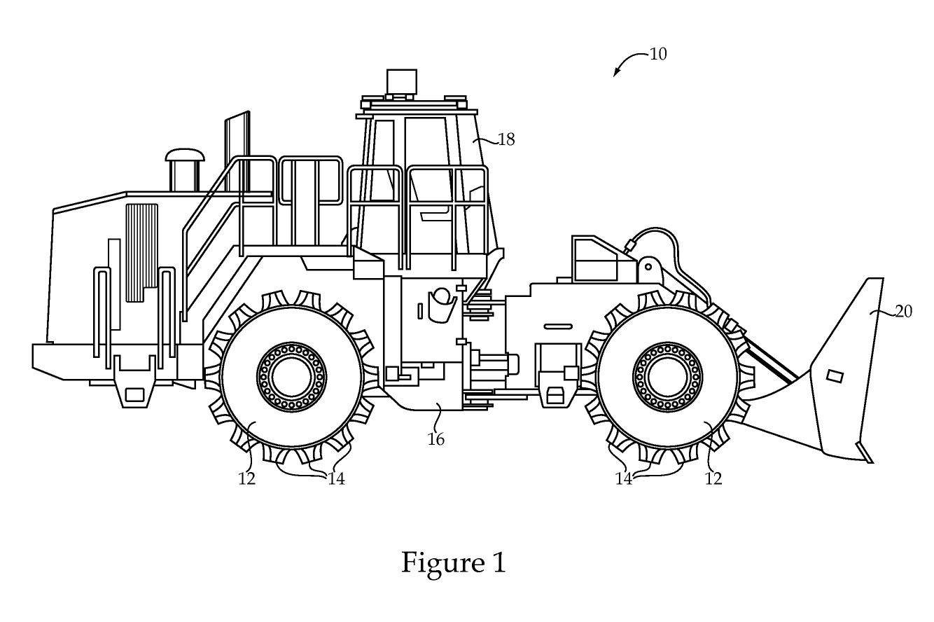

An exemplary embodiment of a compactor 10 is shown generally in FIG. 1. The compactor 10 may be used at a job site, such as a landfill or a construction site, to compact materials, and may generally include compactor wheels 12, or other similar ground engaging elements, such as rollers, having wheel tips 14, or teeth. The compactor wheels 12, embodiments of which will be discussed later in greater detail, may be used to crush materials, such as, for example, waste or soil, as the compactor 10 is moved throughout the job site. The compactor 10 may also include a frame, or chassis, 16 for supporting the compactor wheels 12 and other well known components, such as an operator control station 18 and an implement, such as a bucket or blade 20. The compactor 10 may also include an internal combustion engine (not shown) and a variety of mechanical, hydraulic and/or electrical systems for performing known functions. Such components and/or systems are well known to those skilled in the art and, therefore, will not be discussed herein in greater detail.

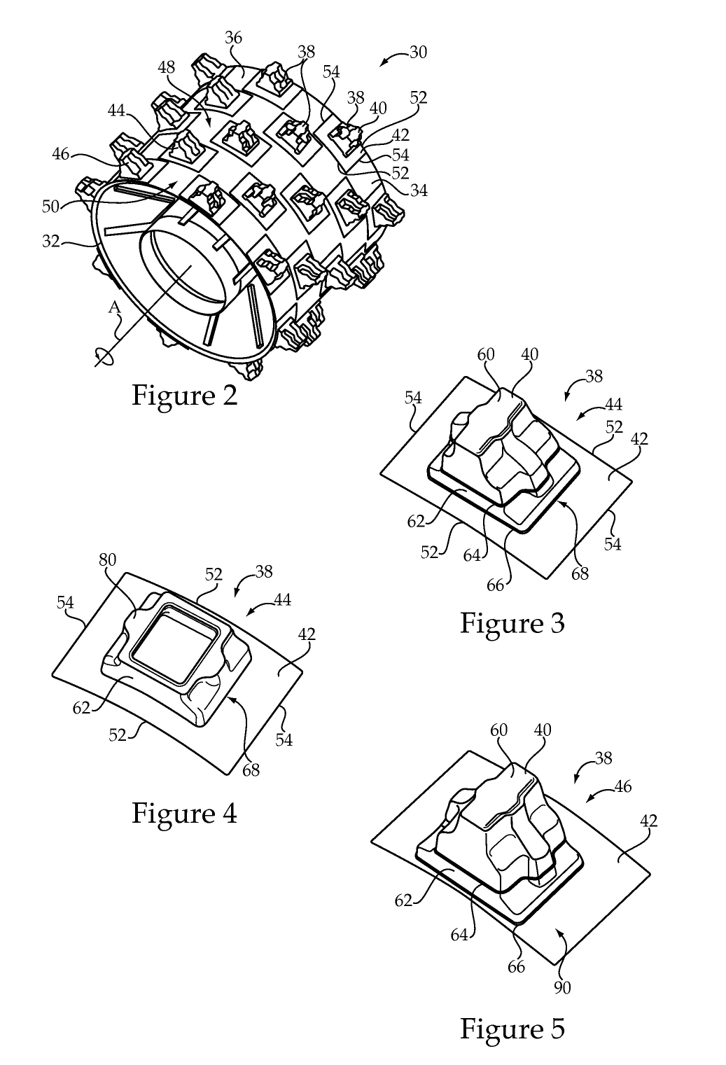

Turning now to FIG. 2, a compactor wheel assembly 30, according to the present disclosure, is shown. The compactor wheel assembly 30, which may be used with the compactor 10 of FIG. 1, includes a cylindrical wheel base, or rim, 32 having an axis of rotation A. A ground engaging wear surface 34, which will be discussed below, may represent all or a portion of a circumferential surface 36 of the cylindrical wheel base 32 having contact with the ground and/or materials to be compacted. The compactor wheel assembly 30 may also include a plurality of wrapper tip assemblies 38 distributed about the circumferential surface 36 of the cylindrical wheel base 32. Each wrapper tip assembly 38 may generally include a wheel tip 40 and a wrapper plate 42.

The wrapper tip assemblies 38 may be provided in a pattern about the circumferential surface 36 of the cylindrical wheel base 32 that is selected to provide desired compaction and/or fraction capabilities of the compactor wheel assembly 30. For example, as shown in the exemplary embodiment, the wrapper tip assemblies 38 may be provided in circumferential rows about the cylindrical wheel base 32. Further, the wrapper tip assemblies 38 may be staggered in an axial direction, relative to axis A, across the cylindrical wheel base 32. According to the exemplary embodiment, the wrapper tip assemblies 38 may include one of an inner wrapper tip assembly 44 and an outer wrapper tip assembly 46. The inner wrapper tip assemblies 44 may be attached to a central segment 48 of the circumferential surface 36 of the cylindrical wheel base 32, while the outer wrapper tip assemblies 46 may be attached to a peripheral segment 50 of the circumferential surface 36 of the cylindrical wheel base 32. Both of the inner wrapper tip assemblies 44 and the outer wrapper tip assemblies 46 will be discussed below in greater detail.

The wrapper plate 42 of each wrapper tip assembly 38 may be arcuate and may represent a segment of a cylinder, such as the cylindrical wheel base 32. Specifically, according to the exemplary embodiment, an inner surface of the arcuate wrapper plate 42 may have a surface contour corresponding to an outer surface contour of the cylindrical wheel base 32. Each arcuate wrapper plate 42, which may include axially spaced sides 52 and circumferentially spaced sides 54, may be secured into mating engagement with the cylindrical wheel base 32, or circumferential surface 36 thereof, using any known attachment means. According to an exemplary embodiment, the arcuate wrapper plates 42 may be welded to the circumferential surface 36, as will be described below.

Referring now to FIG. 3, each wheel tip 40 may include a wheel tip cap 60 and a wheel tip base 62 and, therefore, may also be referred to as a two-piece wheel tip. However, wheel tips having any number of components, including one-piece tips and tips comprising three or more pieces, may also be used with the wrapper tip assemblies 38 of the present disclosure. Although a unique pyramid shape is shown, it should be appreciated that the wheel tips 40 described herein may have alternative shapes and configurations, which may be selected based on compacting and/or fraction capabilities. Further, the wheel tips 40 may be hollow or solid, and may be made from a variety of materials, as will be discussed below. According to the exemplary embodiment, the wheel tip cap 60 or, more specifically, a peripheral portion of a bottom surface thereof, may be attached to the wheel tip base 62 at a first weld joint 64, while the wheel tip base 62, or peripheral portion of a bottom surface thereof, may be attached to the arcuate wrapper plate 42 at a second weld joint 66. For each inner wrapper tip assembly 44, such as the one shown in FIG. 3, the wheel tip 40 or, more specifically, the wheel tip base 62 may be attached at a central portion 68 of the arcuate wrapper plate 42, as will be discussed below. The width of the weld seams provided at the weld joints should be selected to provide sufficient joint strength capable of withstanding normal operation of the compactor wheel assembly 30. Further, although not required, any of the weld joints described herein may be provided along chamfered edge surfaces of either of the components being attached to improve the attachment, or joint strength, thereof.

As an alternative to welding, one or more of the components of the wrapper tip assemblies 38 may be cast together as an integral component. For example, as shown in FIG. 4, the wrapper tip assemblies 38 may include a wrapper tip assembly casting 80 that includes the wheel tip base 62 and the arcuate wrapper plate 42. According to an alternative embodiment (not shown), the wrapper tip assembly casting 80 may also include the wheel tip cap 60. However, it may be desirable to utilize different materials for one or more of the components of the wrapper tip assemblies 38. Specifically, for example, it may be desirable to utilize a material for the wheel tip cap 60 having a greater hardness, wear resistance or strength than a material selected for the wheel tip base 62. According to such embodiments, an integral casting including both the wheel tip cap 60 and wheel tip base 62 may not be desirable.

An outer wrapper tip assembly 46 is shown generally in FIG. 5 and may be similar to inner wrapper tip assembly 44 with the exception of the positioning of the wheel tip 40 relative to the arcuate wrapper plate 42. Specifically, the wheel tip 40 of the outer wrapper tip assembly 46 may be attached to an edge portion 90 of the arcuate wrapper plate 42. As shown in FIG. 2, the outer wrapper tip assembly 46 may then be attached to the peripheral segment 50 of the circumferential surface 36 of the cylindrical wheel base 32 such that the wheel tip 40 is positioned as close as possible to a circumferential edge of the cylindrical wheel base 32. Such positioning may reduce wear at portions of the ground engaging wear surface 34 that may be more susceptible to wear, such as edges of the circumferential surface 36. Inner wrapper tip assemblies 44, having wheel tips 40 centrally positioned relative to the arcuate wrapper plates 42, may be used along the central segment 48 of the circumferential surface 36, where an increased susceptibility to wear may not be as great.

Although the components of the wrapper tip assemblies 38 may be formed from a similar material, such as a durable and wear resistant steel, it may be desirable to utilize different materials for one or more components of the wrapper tip assemblies 38. For example, the wheel tip cap 60 may be formed from a steel that is selected to provide desired wear performance in a landfill or construction operating environment. The wheel tip base 62 and/or wrapper plate 42, however, may be formed from a steel that is selected to provide desired weldability characteristics. Thus, according to one embodiment, the wheel tip base 62 and/or wrapper plate 42 may have a first hardness, while the wheel tip cap 60 may have a second hardness that is greater than the first hardness.

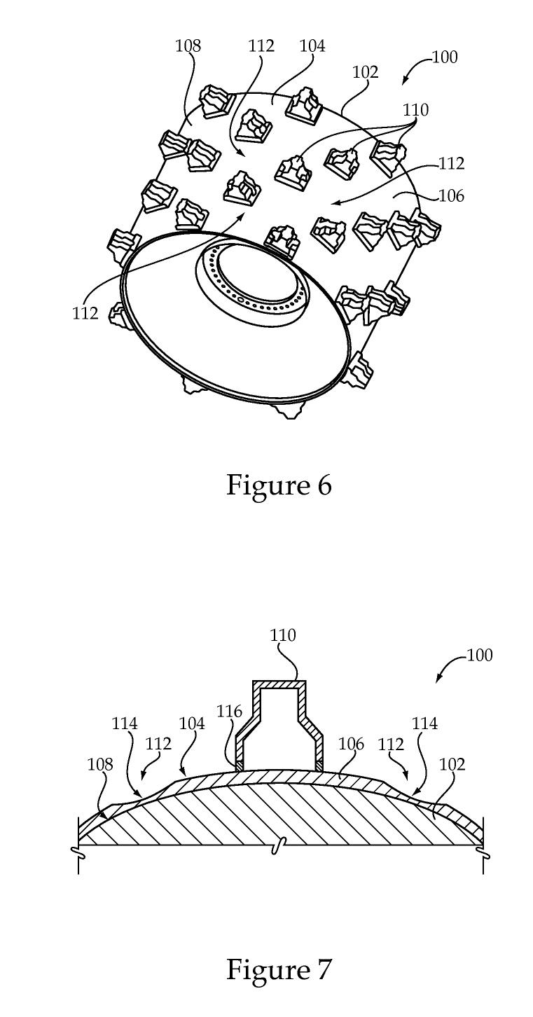

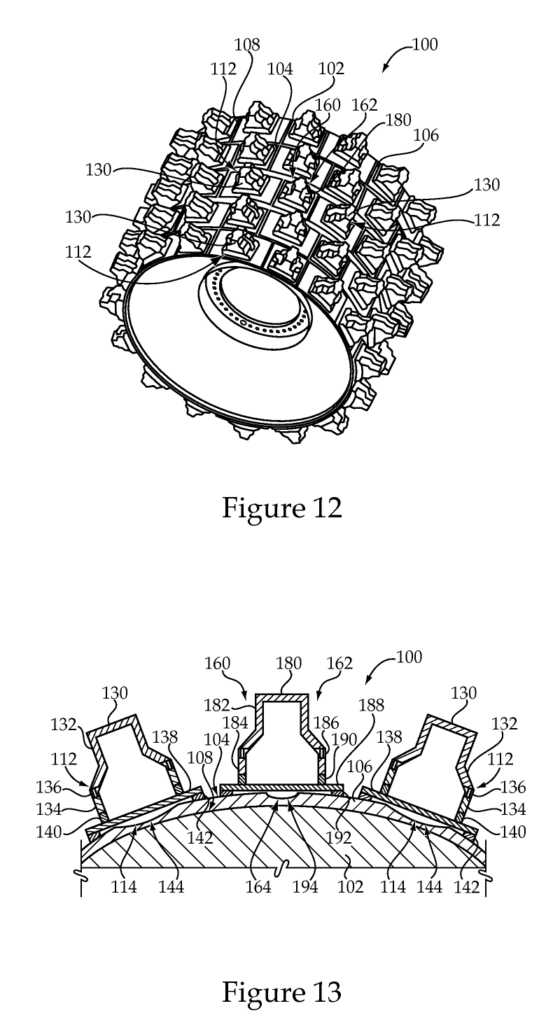

According to the present disclosure, each of the wrapper tip assemblies 38 may include a replacement material portion, which will be discussed with reference to FIGS. 6-15. Specifically, a method of servicing a compactor wheel assembly will be discussed in the following Figures to illustrate the replacement material portions disclosed herein. Starting with FIG. 6, a compactor wheel assembly 100, including a cylindrical wheel base 102, or rim, having a ground engaging wear surface 104, is shown. According to the exemplary embodiment, the compactor wheel assembly 100 may include a core wrapper 106, also shown in FIG. 7, extending about a circumference 108 of the cylindrical wheel base 102 and including the ground engaging wear surface 104. The core wrapper 106 may include a steel wrapper having a uniform thickness that is shaped to engage the circumference 108 of the cylindrical wheel base 102. The core wrapper 106 may be welded, or otherwise attached, to the cylindrical wheel base 102 to protect the cylindrical wheel base 102 from wear and, possibly, extend the service life thereof.

The compactor wheel assembly 100 may also include a plurality of wheel tips 110 distributed about the circumference 108 of the cylindrical wheel base 102. Specifically, for example, the wheel tips 110 may be attached directly to the core wrapper 106. Further, the wheel tips 110 may be attached by manufacturers of the compactor wheel assembly 100 and, as such, may also be referenced as original wheel tips or previously attached wheel tips. After a number of hours of operation, the wheel tips 110, and other portions of the compactor wheel assembly 100, such as first wear positions 112, may become worn and, as such, may require maintenance. Such wear may occur from normal operation of the compactor wheel assembly 100, including a wearing away or distortion of surface area due to repeated contact. Turning now to FIG. 7, a cross section of a portion of the cylindrical wheel base 102, according to the configuration of FIG. 6, is shown. Specifically, FIG. 7 illustrates first wear positions 112, which may include first wear depressions 114, which have been exaggerated for illustrative purposes, of the ground engaging wear surface 104. As should be appreciated, the ground engaging wear surface 104 may include the core wrapper 106 or other circumferential portion of the cylindrical wheel base 102. Wheel tips 110, which may also be worn, may be attached to the core wrapper 106 at a weld joint 116.

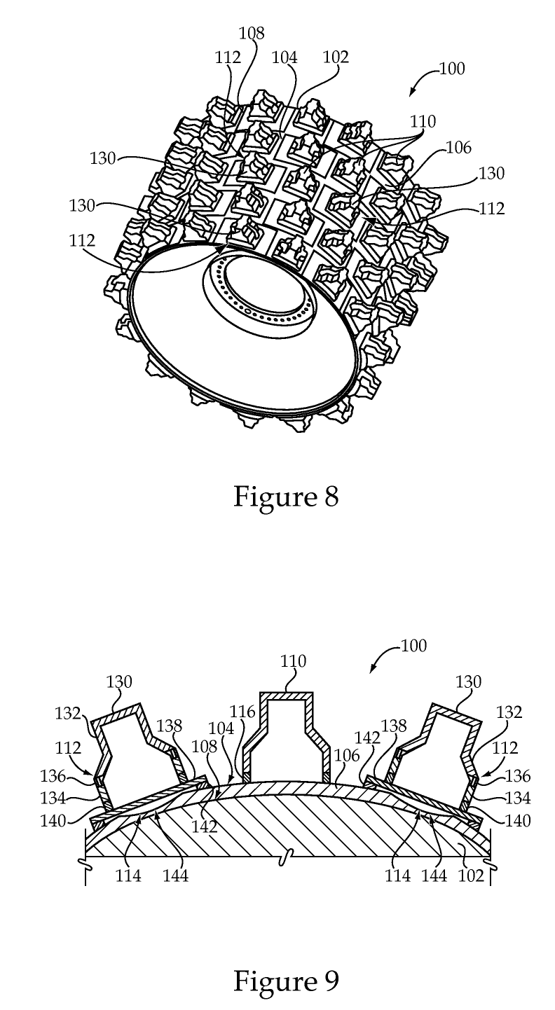

According to a first step in the servicing method described herein, wrapper tip assemblies 130 may be attached at the first wear positions 112, which are spaced between the original wheel tips 110, of the cylindrical wheel base 102 or, more specifically, the core wrapper 106, as shown in FIG. 8. According to one method of servicing, a first set of wrapper tip assemblies 130 may be attached at first wear positions 112 of the cylindrical wheel base 102, as shown. This may be performed after a predetermined number of operation hours, such as, for example, after about 10,000 hours, or after detection of a specific level of wear. As described above, and shown in FIG. 9, each wrapper tip assembly 130 may include a wheel tip cap 132 attached to a wheel tip base 134 at a first weld joint 136, while the wheel tip base 134 may be attached to an arcuate wrapper plate 138 at a second weld joint 140. The arcuate wrapper plate 138 may be attached to the core wrapper 106 at a third weld joint 142.

As shown in the cross sectional view of FIG. 9, when attaching the wrapper tip assemblies 130 to the cylindrical wheel base 102, replacement material portions 144 of the wrapper tip assemblies 130 may be positioned over, and maybe even within, the first wear depressions 114 of the ground engaging wear surface 104. More specifically, according to the exemplary embodiment, replacement material portions 144 of the arcuate wrapper plates 138 of the first set of wrapper tip assemblies 130 may be secured to the cylindrical wheel base 102 at the first wear depressions 114. Thus, the arcuate wrapper plates 138, which may have a uniform thickness, may replace a thickness of the core wrapper 106 that has been worn away. For embodiments that do not utilize the core wrapper 106, the replacement material portions 144, which may include a bottom portion, or surface, of the wrapper plates 138, may replace a thickness of the corresponding circumferential surface of the cylindrical wheel base 102.

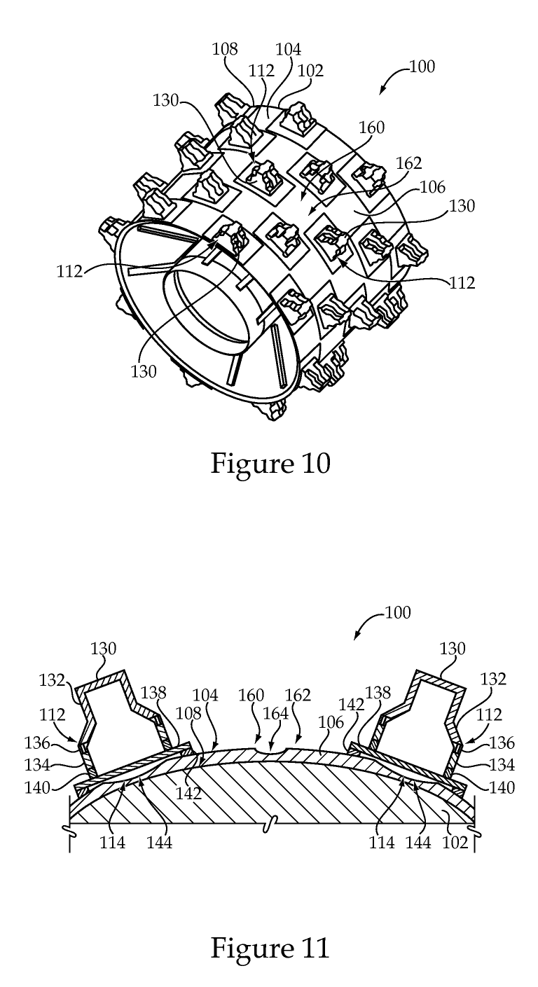

After the first set of wrapper tip assemblies 130 are attached to the cylindrical wheel base 102, the previously attached wheel tips 110, or original wheel tips, may be removed from original wheel tip positions 160, as shown in FIGS. 10 and 11. The original wheel tip positions 160 are different than the first wear positions 112 and may represent positions of the cylindrical wheel base 102 at which the wheel tips 110 were attached by manufacturers. Although this step is described as being performed after the first set of wrapper tip assemblies 130 have been attached to the cylindrical wheel base 102, it should be appreciated that the original wheel tips 110 may be removed before the first set of wrapper tip assemblies 130 are attached. After an additional number of operation hours, the first set of wrapper tip assemblies 130 and other portions of the compactor wheel assembly 100, such as second wear positions 162, may become worn and, as such, may require maintenance. As should be appreciated, the second wear positions 162 may correspond to the original wheel tip positions 160 and may include any portions of the circumferential surface of the cylindrical wheel base 102, excluding the positions of the first set of wrapper tip assemblies 130. FIG. 11 illustrates the second wear positions 162, which may include second wear depressions 164 of the ground engaging wear surface 104.

At a next stage of servicing, a second set of wrapper tip assemblies 180 may be attached at the second wear positions 162, or original wheel tip positions, of the cylindrical wheel base 102. This may be performed after an additional number of operation hours, such as, for example, after about 20,000 hours, or after detection of a specific level of wear. As described above, and shown in FIG. 13, each wrapper tip assembly 180 of the second set of wrapper tip assemblies 180 may include a wheel tip cap 182 attached to a wheel tip base 184 at a first weld joint 186, while the wheel tip base 184 may be attached to an arcuate wrapper plate 188 at a second weld joint 190. The arcuate wrapper plate 188 may be attached to the core wrapper 106, or a corresponding circumferential surface of the cylindrical wheel base 102, at a third weld joint 192.

As shown in the cross sectional view of FIG. 13, when attaching the second set of wrapper tip assemblies 180, replacement material portions 194 of the second set of wrapper tip assemblies 180 may be positioned over or within the second wear depressions 164 of the ground engaging wear surface 104. More specifically, according to the exemplary embodiment, replacement material portions 194 of the arcuate wrapper plates 188 of the second set of wrapper tip assemblies 180 may be secured to the cylindrical wheel base 102 at the second wear depressions 164. Thus, the arcuate wrapper plates 188 may replace a thickness of the core wrapper 106 that has been worn away. For embodiments that do not utilize the core wrapper 106, the replacement material portions 194 may replace a thickness of a corresponding circumferential surface of the cylindrical wheel base 102.

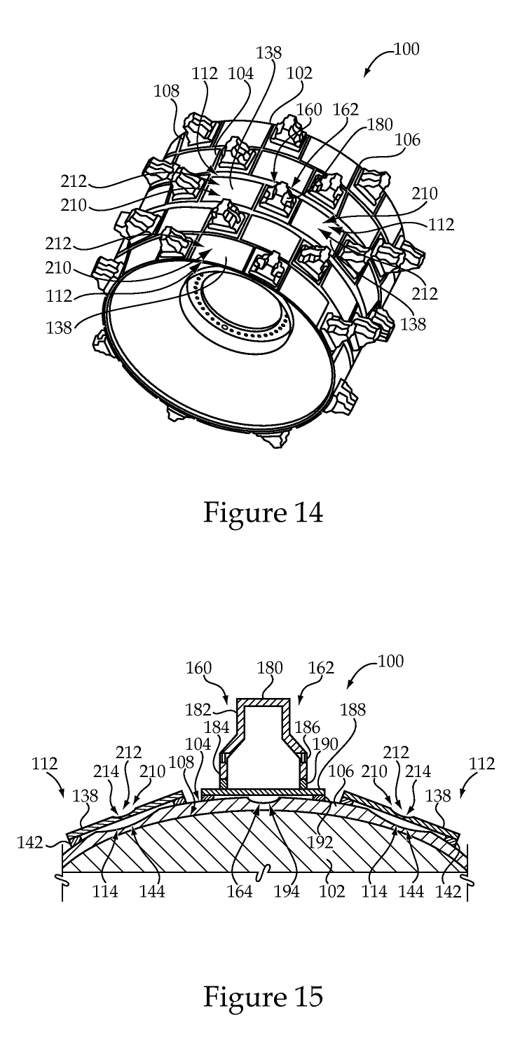

Finally, as shown in FIGS. 14 and 15, wheel tips or, more specifically, the wheel tip caps 132 and wheel tip bases 134 of the first set of wrapper tip assemblies 130 may be removed from the cylindrical wheel base 102, leaving the arcuate wrapper plates 138 of the first set of wrapper tip assemblies 130 attached to the core wrapper 106. Removing the wheel tips of the first set of wrapper tip assemblies 130, such as by removing the second weld joint 140, exposes ground engaging wear surfaces 210 of the arcuate wrapper plates 138. After an additional number of operation hours, the second set of wrapper tip assemblies 180 and other portions of the compactor wheel assembly 100, such as third wear positions 212, may become worn and, as such, may require maintenance. As should be appreciated, the third wear positions 162 may correspond to the first wear positions 112 and may include the ground engaging wear surfaces 210 of the arcuate wrapper plates 138. FIG. 15 illustrates the third wear positions 212, which may include third wear depressions 214 of the arcuate wrapper plates 138.

Although not shown, subsequent steps of servicing the compactor wheel assembly 100 may include removing worn wheel tips, which may include wheel tip caps and wheel tip bases, and attaching new wheel tips at positions other than the positions from which the worn wheel tips are being removed. These wheel tips may be attached and removed from previously attached wrapper plates, and, when exposed surfaces of the wrapper plates become worn, wrapper tip assemblies, including new wrapper plates, may be used in the replacement steps.

### INDUSTRIAL APPLICABILITY

The present disclosure may be applicable to compactor wheels having wheel tips, or teeth, supported about a cylindrical wheel base or rim. Further, the present disclosure may be particularly applicable to compactor wheels having wheel tips and other ground engaging wear surfaces that are subject to wear and, as such, may require maintenance, such as periodic replacement. Yet further, the present disclosure may be applicable to increasing the service life of such compactor wheels.

Referring generally to FIGS. 1-15, a compactor 10 may be used at a job site, such as a landfill or a construction site, to compact materials, and may generally include compactor wheels 12, or other similar ground engaging components, such as rollers, having wheel tips 14, or teeth. The compactor wheels 12 may be used to crush materials, such as, for example, waste or soil, as the compactor 10 is moved throughout the job site. According to a specific embodiment, shown in FIG. 6, a compactor wheel assembly 100 may include a cylindrical wheel base 102 having a ground engaging wear surface 104, as described above. The compactor wheel assembly 100 may include a core wrapper 106 extending about a circumference 108 of the cylindrical wheel base 102 and including the ground engaging wear surface 104. The compactor wheel assembly 100 may also include a plurality of wheel tips 110 distributed about the circumference 108 of the cylindrical wheel base 102. After a number of hours of operation, the wheel tips 110, and other portions of the compactor wheel assembly 100, such as first wear positions 112, may become worn and, as such, may require maintenance.

According to a first step in the servicing method described herein, a first set of wrapper tip assemblies 130 may be attached at the first wear positions 112 of the cylindrical wheel base 102, as shown in FIG. 8. This may be performed after a predetermined number of operation hours, such as, for example, after about 10,000 hours, or after detection of a specific level of wear. As shown in the cross sectional view of FIG. 9, when attaching the first set of wrapper tip assemblies 130 to the cylindrical wheel base 102, replacement material portions 144 of the wrapper tip assemblies 130 or, more specifically, the wrapper plates 138 may be positioned over or within first wear depressions 114 of the ground engaging wear surface 104. Thus, the arcuate wrapper plates 138 may replace a thickness of the core wrapper 106, or corresponding circumferential surface of the cylindrical wheel base 102, that has been worn away.

After the first set of wrapper tip assemblies 130 are attached to the cylindrical wheel base 102, the previously attached wheel tips 110, or original wheel tips, may be removed from original wheel tip positions 160, as shown in FIGS. 10 and 11. After an additional number of operation hours, the first set of wrapper tip assemblies 130 and other portions of the compactor wheel assembly 100, such as second wear positions 162, may become worn and, as such, may require maintenance. The second wear positions 162, which may correspond to the original wheel tip positions 160, may exhibit wear, or increased wear, due to the removal of the previously attached wheel tips 110, such as by removal of the weld joints 116.

At a next stage of servicing, a second set of wrapper tip assemblies 180 may be attached at the second wear positions 162, or original wheel tip positions, of the cylindrical wheel base 102. This may be performed after an additional number of operation hours, such as, for example, after about 20,000 hours, or after detection of a specific level of wear. As shown in the cross sectional view of FIG. 13, when attaching the second set of wrapper tip assemblies 180 to the cylindrical wheel base 102, replacement material portions 194 of the second set of wrapper tip assemblies 180 may be positioned over or within second wear depressions 164 of the ground engaging wear surface 104 to replace surface thicknesses thereof.

Next, as shown in FIGS. 14 and 15, wheel tips or, more specifically, the wheel tip caps 132 and wheel tip bases 134 of the first set of wrapper tip assemblies 130 may be removed from the cylindrical wheel base 102, leaving the arcuate wrapper plates 138 of the first set of wrapper tip assemblies 130 attached to the core wrapper 106. Removing the wheel tips, such as by removing the second weld joint 140, of the first set of wrapper tip assemblies 130 exposes ground engaging wear surfaces 210 of the arcuate wrapper plates 138.

Subsequent steps of servicing the compactor wheel assembly 100 may include removing worn wheel tips, which may include wheel tip caps and wheel tip bases, and attaching new wheel tips at positions other than the positions from which the worn wheel tips are being removed. These wheel tips may be attached and removed from previously attached wrapper plates, and, when exposed surfaces of the wrapper plates become worn, wrapper tip assemblies, including new wrapper plates, may be used in the replacement steps.

As should be appreciated, the servicing method of the present disclosure, utilizing the wrapper tip assemblies described herein, may provide a longer service life for compactor wheels, or compactor wheel assemblies. Since conventional servicing methods include removal and replacement of wheel tips at the same positions of the compactor wheel, the compactor wheel, or surfaces thereof, may only withstand a limited number of wheel tip replacements. The replacement strategy provided herein, however, may allow additional wheel tip replacements, which may effectively extend the service life of the compactor wheel or surfaces thereof, such as a core wrapper. Specifically, the service life of such components may be extended by alternating wheel tip locations when servicing the compactor wheel and providing replacement material portions for worn surfaces of the compactor wheel, as described herein.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A compactor wheel assembly, including:
a cylindrical wheel base having a ground engaging wear surface; and
a wrapper tip assembly including a wheel tip and a wrapper plate, wherein the wrapper plate includes a replacement material portion positioned over a wear depression of the ground engaging wear surface.

2. The compactor wheel assembly of claim 1, further including a core wrapper extending about a circumference of the cylindrical wheel base, wherein the replacement material portion is positioned over a wear depression of a ground engaging wear surface of the core wrapper.

3. The compactor wheel assembly of claim 1, wherein the wear depression corresponds to a first wear position of the cylindrical wheel base, wherein the first wear position is different than an original wheel tip position of the cylindrical wheel base.

4. The compactor wheel assembly of claim 1, wherein the wear depression corresponds to a second wear position of the cylindrical wheel base, wherein the second wear position corresponds to an original wheel tip position of the cylindrical wheel base.

5. The compactor wheel assembly of claim 1, wherein the wrapper tip assembly is attached to a peripheral segment of a circumferential surface of the cylindrical wheel base, and the wheel tip is attached to an edge portion of the wrapper plate.

6. The compactor wheel assembly of claim 1, wherein the wrapper tip assembly is attached to a central segment of a circumferential surface of the cylindrical wheel base, and the wheel tip is attached to a central portion of the wrapper plate.

7. The compactor wheel assembly of claim 1, wherein the wheel tip includes a wheel tip cap and a wheel tip base.

8. The compactor wheel assembly of claim 7, wherein the wheel tip cap is attached to the wheel tip base at a first weld joint.

9. The compactor wheel assembly of claim 8, wherein the wheel tip base is attached to the wrapper plate at a second weld joint.

10. The compactor wheel assembly of claim 8, further including a wrapper tip assembly casting including the wheel tip base and the wrapper plate.

11. A wrapper tip assembly for a compactor wheel assembly, including:
an arcuate wrapper plate having a uniform thickness; and
a wheel tip attached to the arcuate wrapper plate and including a wheel tip cap and a wheel tip base, wherein the wheel tip covers a ground engaging wear surface of the arcuate wrapper plate.

12. The wrapper tip assembly of claim 11, wherein the wheel tip base has a first hardness and the wheel tip cap has a second hardness, wherein the second hardness is greater than the first hardness.

13. The wrapper tip assembly of claim 12, wherein the wheel tip cap is attached to the wheel tip base at a first weld joint.

14. The wrapper tip assembly of claim 13, wherein the wheel tip base is attached to the arcuate wrapper plate at a second weld joint.

15. The wrapper tip assembly of claim 13, further including a wheel tip assembly casting including the wheel tip base and the arcuate wrapper plate.

16. A method of servicing a compactor wheel assembly, wherein the compactor wheel assembly includes a cylindrical wheel base having a ground engaging wear surface, the method comprising the steps of:
attaching a wrapper tip assembly over a wear position of the cylindrical wheel base; and
removing a previously attached wheel tip from another position of the cylindrical wheel base that is different from the wear position;
wherein the attaching step includes positioning a replacement material portion of the wrapper tip assembly over a wear depression of the ground engaging wear surface.

17. The method of claim 16, further including:
attaching a first set of wrapper tip assemblies at first wear positions of the cylindrical wheel base; and
removing a first set of original wheel tips from original wheel tip positions of the cylindrical wheel base, wherein the original wheel tip positions are different from the first wear positions;
wherein the step of attaching the first set of wrapper tip assemblies includes positioning replacement material portions of the first set of wrapper tip assemblies over first wear depressions of the ground engaging wear surface.

18. The method of claim 17, wherein the step of attaching the first set of wrapper tip assemblies further includes positioning replacement material portions of wrapper plates of the first set of wrapper tip assemblies over the first wear depressions of the ground engaging wear surface.

19. The method of claim 18, further including:
attaching a second set of wrapper tip assemblies at the original wheel tip positions of the cylindrical wheel base; and
removing wheel tips of the first set of wrapper tip assemblies from the cylindrical wheel base;
wherein the step of attaching the second set of wrapper tip assemblies includes positioning replacement material portions of the second set of wrapper tip assemblies over second wear depressions of the ground engaging wear surface.

20. The method of claim 19, wherein the step of removing the wheel tips of the first set of wrapper tip assemblies includes exposing ground engaging wear surfaces of the wrapper plates of the first set of wrapper tip assemblies.
